(19) United States
(12) Patent Application Publication
(10) Pub. No.: US 2025/0337516 A1
(43) Pub. Date: Oct. 30, 2025

(54) METHOD AND SYSTEM FOR A MACHINE REPRESENTATION OF CHANNELS AND GAPS IN THE BAND SPECTRUM OF A TELECOMMUNICATIONS NETWORK

(71) Applicant: Infinera Corporation, San Jose, CA (US)

(72) Inventors: Nikhil Satyarthi, Bangalore (IN); Ashok Kunjidhapatham, Bangalore (IN); Sanjeev Ramachandran, Bangalore (IN); Baranidhar Ramanathan, Bangalore (IN)

(73) Assignee: Infinera Corporation, San Jose, CA (US)

(21) Appl. No.: 18/806,693

(22) Filed: Aug. 15, 2024

Related U.S. Application Data
(60) Provisional application No. 63/533,087, filed on Aug. 16, 2023.

(51) Int. Cl. H04J 14/02; G06F 16/22

(52) U.S. Cl. CPC H04J 14/02762; G06F 16/2246; H04J 14/0212

(57) ABSTRACT

In some implementations, a device may map active channels within a band spectrum into a first balanced tree data structure wherein each node of the first balanced tree data structure represents a respective channel. The device may identify spectrum gaps within the band spectrum based on the nodes of the first balanced tree data structure and mapping the spectrum gaps into a second balanced tree data structure wherein each node of the second balanced tree data structure represents a respective spectrum gap. The device may update the first balanced tree data structure and the second balanced tree data structure in response to a change detected in an active channel by adding, deleting, or modifying the nodes of the first and second balanced tree data structures to reflect the change in real-time occupancy of the band spectrum.

### BACKGROUND

The present disclosure is directed generally to optical communication systems, and to a representation of channels and gaps in the optical band spectrum.

### SUMMARY

In some implementations, a method is disclosed that comprises a step of mapping, by a device, active channels within a band spectrum into a first balanced tree data structure wherein each node of the first balanced tree data structure represents a respective channel. The method further includes identifying, by the device, spectrum gaps within the band spectrum based on the nodes of the first balanced tree data structure and mapping the spectrum gaps into a second balanced tree data structure wherein each node of the second balanced tree data structure represents a respective spectrum gap. The method also includes updating, by the device, the first balanced tree data structure and the second balanced tree data structure in response to a change detected in an active channel by adding, deleting, or modifying the nodes of the first and second balanced tree data structures to reflect the change in real-time occupancy of the band spectrum.

In some implementations, a device includes one or more processors configured to: maintain a real-time representation of a band spectrum occupancy using a balanced tree data structure to represent channels and gaps. The processors are also configured to update the balanced tree data structure in response to frequency changes associated with the channels to correspondingly adjust representation of the gaps. Moreover, the processors are configured to randomly access the channels and gaps in the balanced tree data structure to minimize fragmentation and optimize spectrum utilization irrespective of bandwidth granularity.

Moreover, in some implementations, a method is provided that includes a step of receiving first and second information associated with a band spectrum, the first information including an identification of first frequencies associated with bands including signals carrying user data. In addition, second information is received that identifies second frequencies associated with gaps in the band spectrum. The method further includes steps of processing the first and second information and displaying a representation of the band and the gaps on a display.

### BRIEF DESCRIPTION OF THE DRAWINGS

FIG. 1 depicts an exemplary optical line system, in accordance with some embodiments of the present disclosure.

FIG. 2 depicts an example power spectral density plot of a band spectrum, consistent with an aspect of the present disclosure.

FIGS. 3a and 3b depict examples of units of bandwidth (or granularity) or slices as referred in the context of a Wavelength Selective Switch (WSS) device used in fiber optics communications, in accordance with some embodiments of the present disclosure.

FIG. 4a illustrates an example in which no channel is present and a gap extends the entire band spectrum;

FIG. 4b illustrates another example in which a channel extends the entire band spectrum with no gaps;

FIGS. 5a and 5b illustrate examples of scenarios involving two channels with one gap, and one channel with two gaps, respectively, in accordance with some embodiments of the present disclosure.

FIGS. 6a-6d depict example balanced tree channel entries and gap entries, in accordance with some embodiments of the present disclosure.

FIG. 7 depicts an example environment for implementing a Spectrum Layout Cache (SLC), in accordance with some embodiments of the present disclosure.

FIG. 8a depicts an example of a high-level flow for determining channel updates in conjunction with a Spectrum Layout Cache (SLC) consistent with some embodiments of the present disclosure.

FIG. 8b shows an example of a balanced tree data structure consistent with an aspect of the present disclosure.

FIG. 9 depicts an example flow associated with a Spectrum Layout Transformer (SLT), in accordance with some embodiments of the present disclosure.

FIG. 10 depicts an example spectrum representation, in accordance with some embodiments of the present disclosure.

### DETAILED DESCRIPTION

The following detailed description of example implementations refers to the accompanying drawings. The same reference numbers in different drawings may identify the same or similar elements.

In telecommunications and networking, the efficient utilization of the frequency spectrum is critical for delivering various services to users and maintaining system performance. The frequency spectrum in technologies such as fiber optic networks, wireless and radio networks, and cable television may divided into bands, each comprising frequencies associated channels that carry user information and unused portions referred to as gaps or frequency gaps associated with an absence of information carrying signals. Managing the representation in real-time of channels and gaps in the spectrum may be difficult, especially due to the dynamic nature of service demand that leads to the constant addition, deletion, and resizing of channels.

Traditional methods face several technical problems. Current representations rely on a model where the spectrum's occupancy information is depicted as a vector with each entry corresponding to a fixed unit of bandwidth or granularity. This approach falls short when the granularity changes, making the model incoherent and necessitating a total overhaul of the data structure—an inefficient and resource-intensive process. Furthermore, pinpointing the exact positions of channels within the spectrum adds complexity, as it requires additional tracking information per vector entry. Addressing such issues may require linear time complexity for access, which becomes impractically slow with scaling.

Another significant problem with the traditional approach arises when reallocating channels into a frequency range that previously constitute a gap to minimize fragmentation within the spectrum. This optimization is critical for maximizing efficient spectrum usage, but due to the granularity-based limitation and the sheer complexity involved in current algorithms, a significant computational overhead is introduced, impacting system performance, when an attempt to re-allocate the channels is made.

Thus, there is a need for a more advanced solution that can address these inefficiencies, adapt to varying bandwidth granularities without loss of data integrity, deliver faster access times, and efficiently manage the spectrum to reduce fragmentation.

Some implementations described herein provide a method for managing the real-time occupancy of the band spectrum with more agility and independent of the granularity. For example, a device maps active channels within a band spectrum into a first balanced tree data structure wherein each node represents a channel. It also identifies spectrum gaps using the nodes of this first balanced tree and maps them into a second balanced tree data structure, where each node represents a gap. This allows the device to update both balanced tree data structures in response to changes detected in an active channel, such as additions, deletions, or modifications. Further features include reallocating bandwidth to minimize gap fragmentation, detecting changes in bandwidth utilization for automatic updates, and providing a visualization of active channels and gaps for a user interface device.

In this way, the method offers a technical advancement in spectrum management by employing a first balanced tree data structure for active channels and a second balanced tree for spectrum gaps, resulting in dynamic and efficient management of spectrum resources. The balanced tree data structure enables logarithmic time complexity for node access and gap identification, which significantly improves the processing performance as the spectrum size and number of channels increases. This technical benefit leads to enhanced spectral efficiency and minimizes the potential for spectrum fragmentation. Additionally, the method's predictive analysis capabilities and the optimization of channel alignments contribute to a more efficient utilization of telecommunications infrastructure. In one example, channels (or interchangeably referred as passbands in the current disclosure), and gaps can be accurately represented in real-time for an optical link including wavelength selective switches (WSSs) that switch channel in a reconfigurable optical add-drop multiplexer (ROADM).

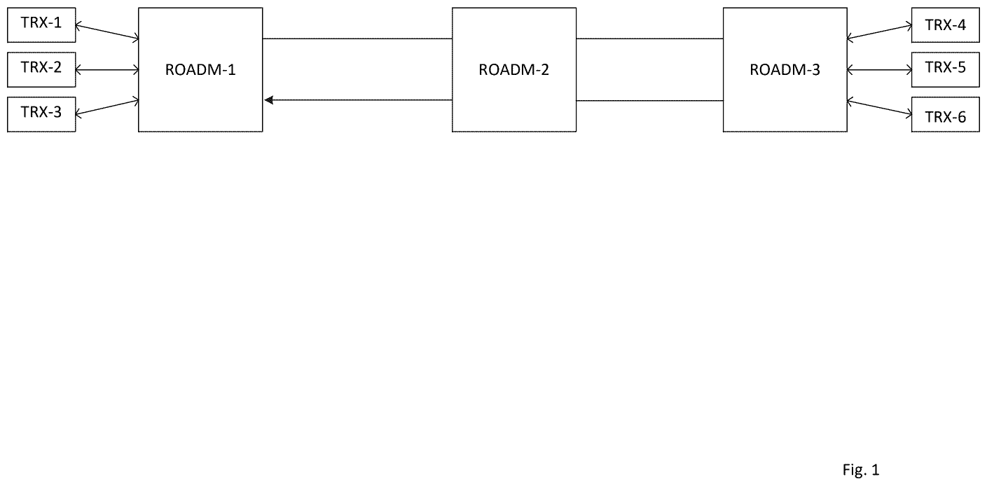

Referring to FIG. 1, an exemplary optical line system is illustrated comprising a series of network elements including Reconfigurable Optical Add-Drop Multiplexers (ROADMs) and Transceivers (TRXs). Starting from the left side of FIG. 1, three transceivers are depicted, labeled as TRX-1, TRX-2, and TRX-3, which are operationally connected to the first Reconfigurable Optical Add-Drop Multiplexer, designated as ROADM-1. ROADM-1 represents a network element that adds, drops, and passes through optical signals, providing flexibility in the management of wavelength channels in optical communication networks. The transceivers, in one example, may constitute transponders for use in the optical line system shown in FIG. 1.

Moving to the right of ROADM-1, a connection is made to another network element, delineated as ROADM-2. ROADM-2 is interposed between ROADM-1 and ROADM-3, which is situated further to the right in the illustration. Each ROADM is depicted as a rectangular block indicating the functionality of these devices in the optical line system. Finally, ROADM-3 is operationally connected to three additional transceivers indicated as TRX-4, TRX-5, and TRX-6, shown on the right side of the figure.

This system architecture allows for the routing and deployment of multiple optical channels through the network, giving operators the ability to dynamically manage the spectrum of wavelengths used for communication purposes. The spatial layout of FIG. 1 is indicative of a chain or series circuit-like connection among the ROADMs, with transceivers serving as the end points for the origination and termination of optical signals.

It should be noted that in the context of this description, the term transceiver is indicative of devices capable of transmitting and receiving optical signals and may include, but is not limited to, lasers, modulators, and photodetectors. Each TRX may be responsible for the conversion and processing of optical and electrical signals within their respective channels.

As indicated above, FIG. 1 is provided as an example. Other examples may differ from what is described with regard to FIG. 1.

A visualization of the overall spectrum occupancy in real time of an optical line system allows a user to identify:
the gaps and fill with Amplified Spontaneous Emission (ASE) noise for balancing the load on the spectrum on the optical link;
the current occupancy and manage the loading of the spectrum on the optical link;
the available bandwidth based on the current occupancy to admit new services; and
the conflicting channel creation or resizing operations against the current spectrum layout.

To meet the above requirements there is a need to represent the real-time spectrum in a form which a software or hardware system to process and execute the read/write operations efficiently.

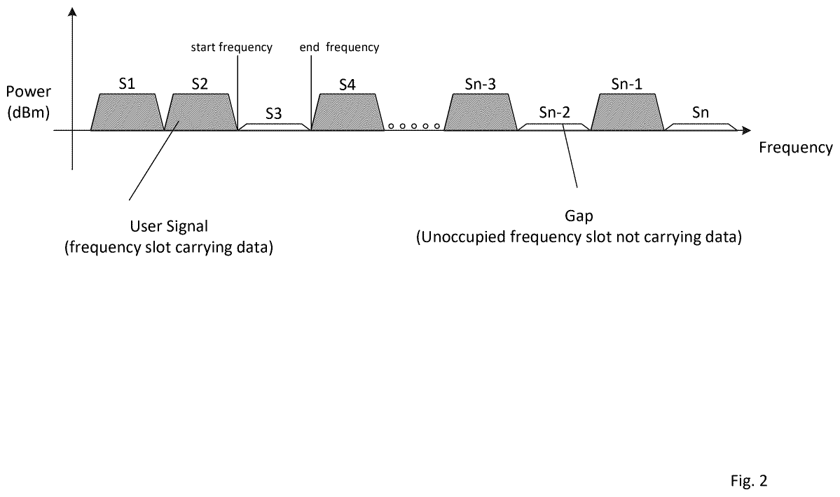

FIG. 2 depicts an example frequency spectrum plot or power spectral density plot that represents the real-time occupancy of a band spectrum. The spectrum plot begins at a start frequency location and extends to an end frequency location, indicating the full range or spectrum of the band spectrum. The band spectrum is comprised of active channels S1, S2, S4, Sn-3, and Sn-1 which are frequencies associated with data carrying channels. The band spectrum is further comprised of gaps S3, Sn-2 and Sn which are frequencies where data carrying channels are absent.

In the invention disclosed, a device maps these active channels into a first balanced tree data structure, wherein each node of the first balanced tree data structure represents a respective channel. Spectrum gaps within the band spectrum are identified based on the nodes of the first balanced tree data structure through the visual representation as shown in FIG. 2. Subsequently, these spectrum gaps are mapped into a second balanced tree data structure, wherein each node of the second balanced tree data structure represents a respective spectrum gap, as indicated by the unoccupied frequencies between the user signals in the figure.

The device updates the first balanced tree data structure and the second balanced tree data structure in response to a change detected in an active channel. The update includes adding, deleting, or modifying the nodes of the first and second balanced tree data structures to reflect the change in real-time occupancy of the band spectrum. These modifications are real-time reflections of the addition, removal, or resizing of channels and the consequent adjustment of the spectrum gaps within the band spectrum.

This spectrum plot in FIG. 2 serves as a visual aid to the conceptual understanding of the mapping and updating processes that the device would implement as part of managing the real-time spectrum occupancy and efficiently utilizing the available spectrum to minimize fragmentation and optimize channel allocation.

As indicated above, FIG. 2 is provided as an example. Other examples may differ from what is described with regard to FIG. 2.

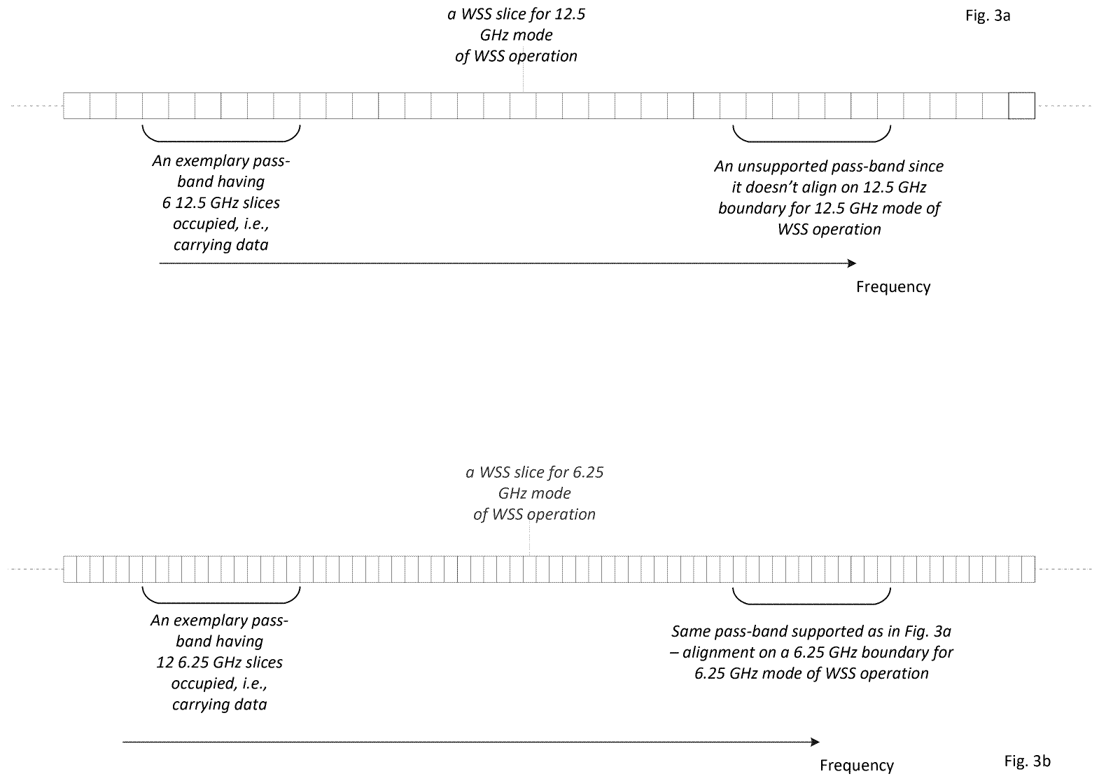

FIGS. 3a and 3b depict examples of units of bandwidth (or granularity) or slices as referred in the context of a Wavelength Selective Switch (WSS) device used in fiber optics communications.

FIG. 3a illustrates a WSS operating in a 12.5 GHz mode. Referencing the figure, an exemplary passband is shown with six 12.5 GHz slices occupied, indicating that these slices are actively carrying data. The figure further displays an unsupported passband, which does not align on the 12.5 GHz boundary necessary for WSS operation in the 12.5 GHz mode, identifying a portion of the spectrum that is not supported under the current operational mode.

FIG. 3b presents a similar visualization for a WSS operating in a 6.25 GHz mode. Here, an exemplary passband shows twelve 6.25 GHz slices or passbands occupied with data, doubling the number of slices compared to the 12.5 GHz mode due to the finer granularity. Furthermore, FIG. 3b illustrates that the previously unsupported passband in FIG. 3a aligns with a 6.25 GHz boundary in this mode, making the passband operable in the 6.25 GHz mode of the WSS. Each slice may be occupied by one or more channels or be devoid of any channels and thus constitute a gap.

As indicated above, FIGS. 3a and 3b are provided as an example. Other examples may differ from what is described with regard to FIGS. 3a and 3b.

Conventional implementations represent the usage of the spectrum through a vector data structure where each entry in the vector represents a slice. However, once the mode of operation of the WSS changes, the vector data structure also needs to adapt to the new mode of operation. Moreover, such a representation incurs linear time-complexity for operations on the data structure which is inefficient. Furthermore, such spectrum usage representations are dependent on device specific constructs. Other multiplexing/de-multiplexing devices may be employed in addition to a WSS

Consistent with the present disclosure, device specific constructs are eliminated by representing the spectrum in a non-discrete frequency scale within discrete spectral slices. This representation, therefore, scales and can be generated for any kind of multiplexing/de-multiplexing device. A representation of used and unused portions of the spectrum may be efficiently generated using a balanced tree structure. In one example, a channel is represented as a node in one balanced tree referred to as channel entries in this disclosure. In addition, a gap is represented as a node in another balanced tree referred to as gap entries.

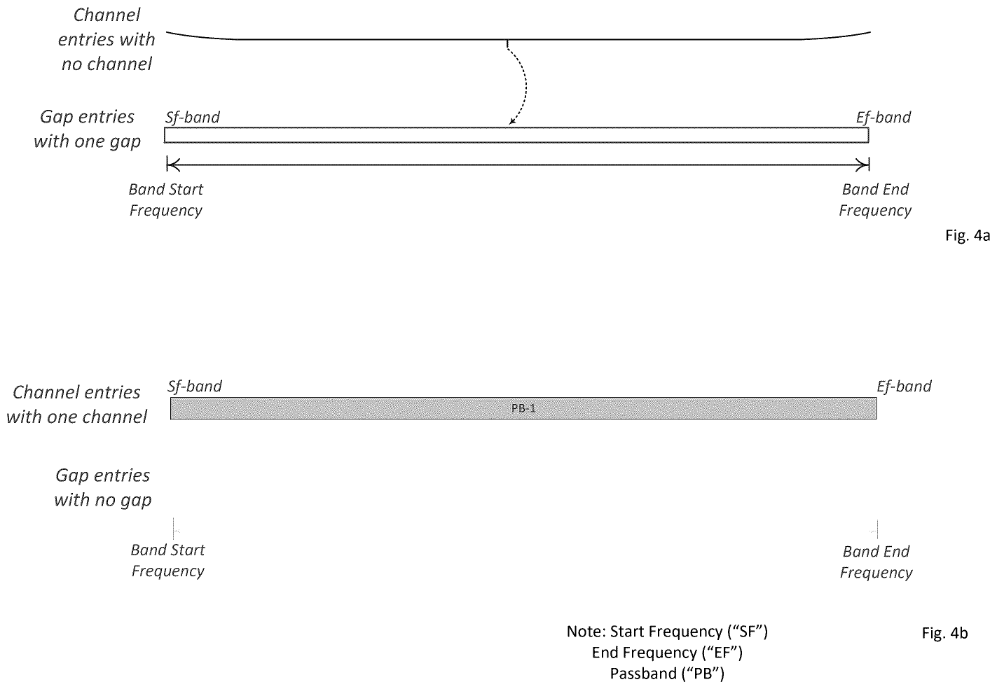

FIGS. 4a and 4b illustrate examples of scenarios involving one channel with no gap and no channel with one gap, respectively The illustrations show the state of the channel entries balanced tree and gap entries balanced tree for each of these specific scenarios as disclosed in the current invention.

Referring to FIG. 4a, no channels are present and a gap extends across the entire band. In FIG. 4b, however, no gaps are present, and one channel extends across the entire band.

As further shown in FIG. 4a, the presence of indicators for both the Start Frequency (‘Sf-band’) and End Frequency (‘Ef-band’) at the boundaries of the depicted gap establishes the gap's frequency range within the band. The overall frequency range of interest is marked by Band Start Frequency (‘Sf-band’) and Band End Frequency (‘Ef-band’) at the extremities of the band.

Turning to FIG. 4b, the Band Start Frequency and Band End Frequency frame the channel's frequency spectrum within the band. The specific boundaries of the passband are demarcated by the Start Frequency (‘SF’) and End Frequency (‘EF’), similarly identified within the bandwidth.

In some implementations, these representations facilitate updating channels and gaps in a data structure through a Spectrum Layout Transformer (SLT). This transformer maps operations such as creation, deletion, expansion, and contraction of channels to the data structure. The Spectrum Layout Cache (SLC) comprises two balanced trees that offer efficient handling and reduced time complexity for accessing and updating channel and gap entries. One balanced tree is referred to as channel entries represents a channel as one of its nodes. Another balanced tree referred to as gap entries represents a gap as one of its nodes.

As indicated above, FIGS. 4a and 4b are provided as an example. Other examples may differ from what is described with regard to FIGS. 4a and 4b.

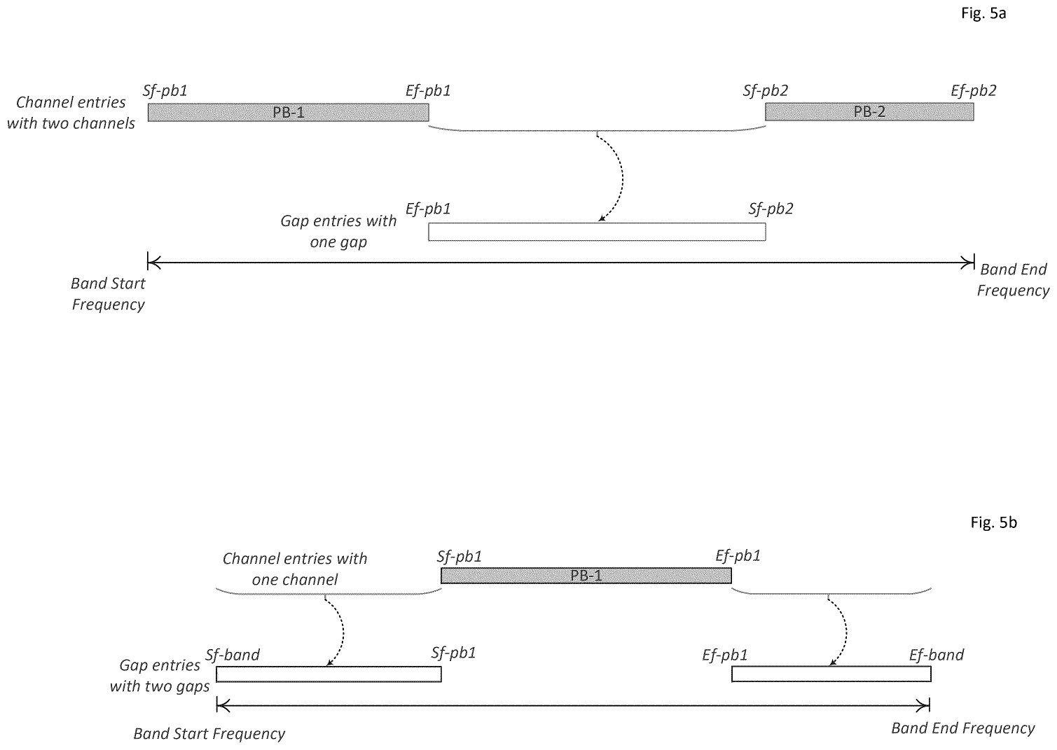

FIGS. 5a and 5b illustrate examples of scenarios involving two channels with one gap, and one channel with two gaps, respectively. In particular, FIGS. 5a and 5b show the state of the channel entries balanced tree and gap entries balanced tree for each of these specific scenarios as disclosed in the current invention.

Reference is now made to FIG. 5a, which shows an example of a channel allocation within a band spectrum. At the beginning of the band spectrum is the Band Start Frequency, extending to the Band End Frequency at the spectrum's end. Within this range, two passbands (PB-1 and PB-2) are depicted as Channel entries. PB-1 commences at Sf-pb1, marking the Start Frequency of the first channel, and concludes at Ef-pb1, designating the End Frequency of the first channel. Similarly, PB-2 starts at Sf-pb2, indicating the Start Frequency of the second channel, and ends at Ef-pb2, which signifies the End Frequency of the second channel. Located between PB-1 and PB-2 is a single gap, as represented by the gap entries, which spans the frequency range not occupied by the two channels. The Start frequency of the gap is inferred as Ef-pb1 and End frequency of the gap is inferred as Sf-pb2. This inference is made by the transform functions which is invoked by the Spectrum Layout Transformer (SLT) which manage the gaps in the gap entries balanced tree representation.

Turning now to FIG. 5b, channel and gap allocation is shown. Similar to FIG. 5A, this scenario includes a Band Start Frequency known as Sf-band, and a Band End Frequency referred to as Ef-band. However, unlike the previous figure, FIG. 5b depicts only a single passband, PB-1, in the Channel entries. This passband begins at Sf-pb1, the Start Frequency of the channel, and concludes at Ef-pb1, the End Frequency of the channel. Thus, FIG. 5b illustrates two gaps positioned within the band spectrum, represented in the gap entries, one gap on each side of PB-1. These gaps reflect the portions of the band spectrum not occupied by a channel. The Start frequency of the first gap is inferred as Sf-band and End frequency of the first gap is inferred as Sf-pb1. The Start frequency of the second gap is inferred as Ef-pb1 and the End frequency of the second gap is inferred as Ef-band. This inference is made by the transform functions which is invoked by the Spectrum Layout Transformer (SLT) which manage the gaps in the gap entries balanced tree representation.

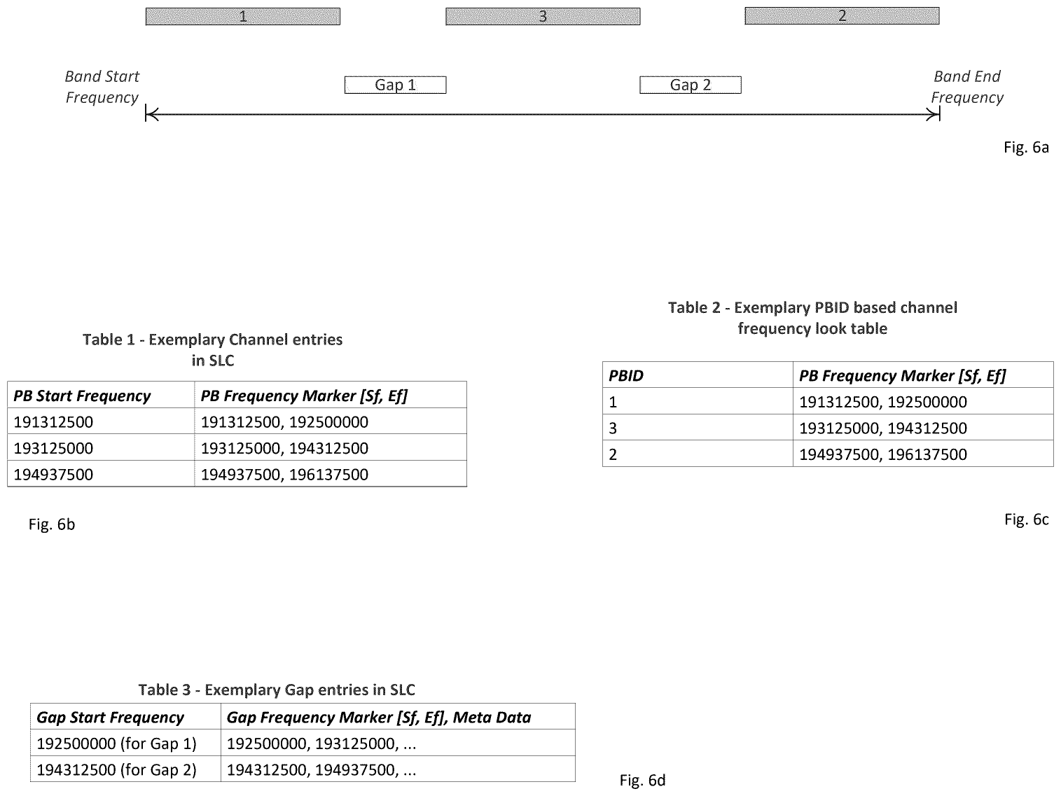

FIGS. 6a-6d depict examples of balanced tree channel entries and gap entries. Referring to FIG. 6a, a band spectrum is depicted with channels 1, 2, and 3, and identified spectrum gaps gap 1 and gap 2. The channels are shown with their respective start frequency and end frequency markers, indicating their positions within the band spectrum. This visual representation assists in understanding how channels are distributed across the frequency band of the spectrum.

Table 1 shown in FIG. 6b lists examples channels in the channel entries balanced tree in the Spectrum Layout Cache (SLC). This table outlines the relationship between each Passband Start Frequency (PB Start Frequency) and its associated PB Frequency Marker, denoting the start and end frequencies of the respective passbands. This structured representation using a balanced tree facilitates efficient access and management of active channels within the band spectrum based on their frequency markers.

Turning attention to FIG. 6c, Table 2 shows an example of a passband identification (“PBID”)-based channel frequency look-up table. This table outlines the relationship between each PBID and its associated PB Frequency Marker, denoting the start and end frequencies of the respective channels. This structured representation facilitates efficient access and management of active channels based on their frequency markers. The lookup table need not necessarily be built using a balanced tree. It may optionally be built using a hash table which may provide search time-complexity of O(1) in Big-O notation, better than a balanced tree.

Referring to FIG. 6d, Table 3 shows additional exemplary gaps in the gap entries balanced tree in the Spectrum Layout Cache (SLC). This table identifies gaps within the band spectrum through Gap Start Frequency, Gap Frequency Marker [Sf, Ef], and optional associated meta-data if any. The systematic tracking of spectrum gaps and their attributes provides a comprehensive approach to spectrum management.

The disclosed device maps active channels within a band spectrum into a first balanced tree data structure, where each node of the first balanced tree represents a channel. Spectrum gaps within the band spectrum are mapped into a second balanced tree data structure, with each node representing a spectrum gap. Both balanced tree data structures are dynamically updated in real-time in response to changes detected in active channels, such as additions, deletions, or modifications, ensuring efficient spectrum management.

This method enables rapid identification and access to spectrum gaps, employing the second balanced tree data structure. This approach allows for generic frequency metric management, agnostic to bandwidth granularity, and achieves better time complexity for telecommunications applications, including fiber optic networks, wireless and radio networks, and cable television systems. The use of balanced tree data structures optimizes spectrum occupancy updates with O(log[N]) time complexity, in Big-O notation, providing a versatile and robust framework for spectrum management across various technological domains.

Time complexity is a measure of how long an algorithm takes to run as a function of the input size. As generally understood, Big-O notation is a mathematical notation used to describe the upper bound of the time complexity of an algorithm. Big-O notation provides a way to classify algorithms based on their performance as the input size grows, often referred to as “order of growth”.

O(f(n)): Represents the upper bound of the time complexity, where:

O: Stands for “order of”

f(n): Is a function that describes how the running time grows as the input size n increases.

### Common Big-O Notations:

O(1): Constant time. The algorithm's runtime is independent of the input size.

O(log n): Logarithmic time. The runtime grows logarithmically with the input size.

O(n): Linear time. The runtime grows linearly with the input size.

O(n log n): Linearithmic time. A combination of linear and logarithmic growth.

O(n\hat{ }2): Quadratic time. The runtime grows quadratically with the input size.

O(2\hat{ }n): Exponential time. The runtime grows exponentially with the input size.

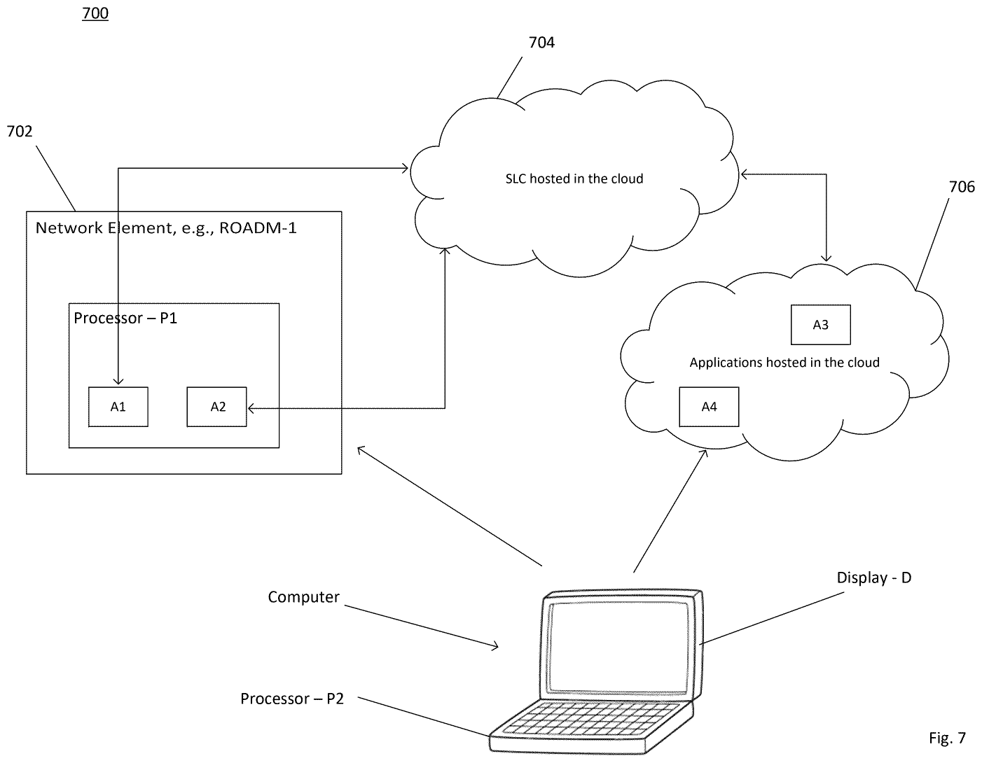

FIG. 7 depicts an example environment 700 in which a system for spectrum layout caching operates. Environment 700 includes a network element 702, which may include a Reconfigurable Optical Add-Drop Multiplexer (ROADM), as noted above, or similar device within a telecommunications network. The network element 702 includes a processor P1, which is responsible for executing various functions integral to spectrum occupancy management. The processor P1 manages operations such as spectrum allocation, deallocation, and rearrangement, all of which are crucial for maintaining efficient spectrum usage.

As further shown in FIG. 7, applications A1 and A2 may run on network element 702. These applications interface with the processor P1 to execute tasks pertinent to spectrum management, ensuring that the band spectrum's real-time occupancy is appropriately monitored and managed.

Environment 700 further includes a Spectrum Layout Cache (SLC), which may be hosted in cloud 704. The SLC is dynamically maintained and updated with real-time data regarding channels and spectrum gaps. This cloud-hosted repository ensures that the representation of the band spectrum is independent of bandwidth granularity and the underlying telecommunications device making the system widely applicable across different telecommunications technologies for example—wireless and radio networks, cable television networks and alike.

Additionally, the environment 700 includes a set of applications A3 and A4 hosted in the same or different cloud 706. These applications, A3 and A4, can access the SLC to retrieve current spectrum occupancy data, enabling them to dynamically manage telecommunication services and adjustments in real-time.

User interaction with the system is facilitated through a computer equipped with processor P2. This computer interfaces with the network element 702 and the SLC, allowing users to monitor, configure, and manage the spectrum layout, including a representation of the channels and gaps in the spectrum, and project this representation through a user interface displayed on display D.

By incorporating cloud-hosted components, in one example, and robust processing capabilities, the system provides real-time visualization and management of spectrum resources, significantly reducing fragmentation and optimizing spectrum utilization across various telecommunications technologies. Alternatively, the SLC may reside on network element 702.

As indicated above, environment 700 shown in FIG. 7 is provided as an example. Other examples may differ from what is described with regard to FIG. 7.

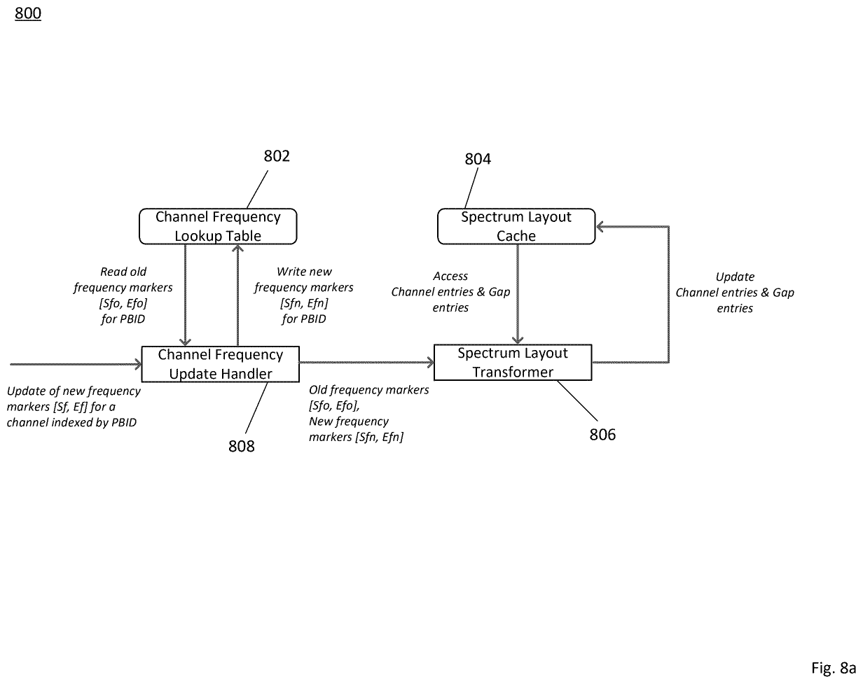

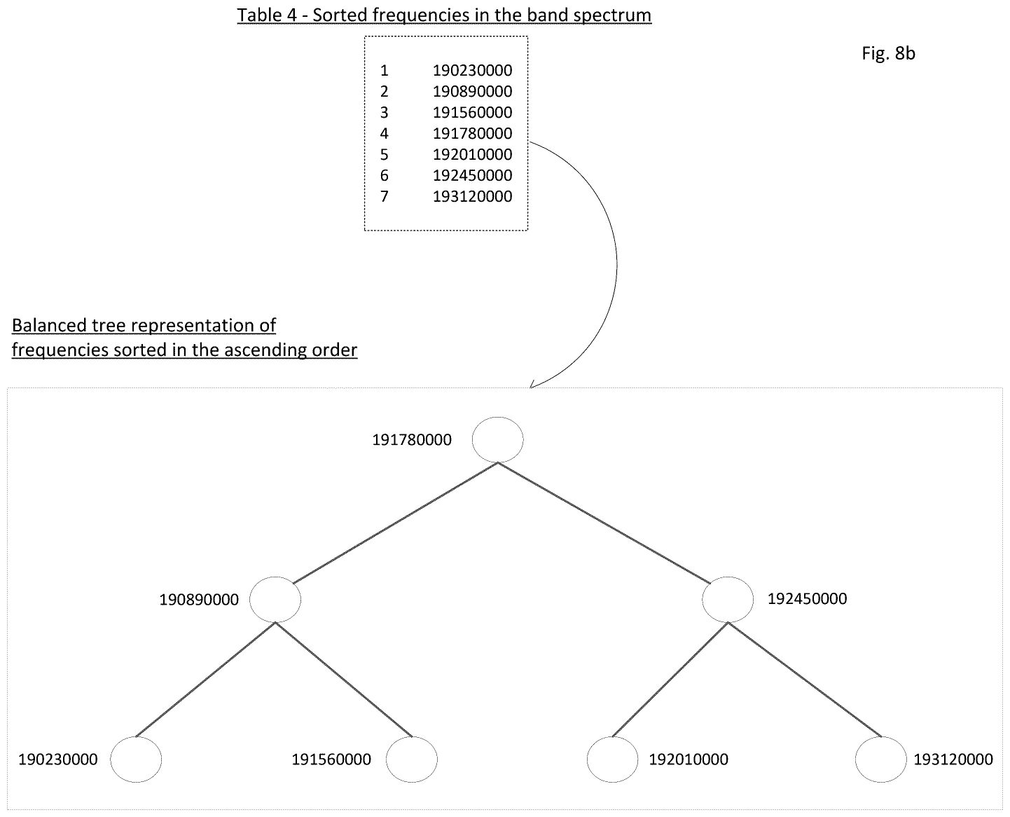

FIG. 8a depicts an example 800 of a high-level flow of channel updates leading to updates in a Spectrum Layout Cache (SLC). The figure shows an interconnected system comprising various components that contribute to maintaining and managing the real-time occupancy of a band spectrum, particularly with respect to channels (or passbands) and gaps within the spectrum.

The Channel Frequency Lookup Table 802 serves as a repository for channel frequency markers associated with different channels or passbands (identified through a unique PBID within the band spectrum). It provides a reference for the current frequency utilization per channel and acts as an indexed source for updates related to the channels.

The Spectrum Layout Cache 804 maintains a real-time representation of the occupancy of the band spectrum. This cache or memory is used by the system to visualize the spectrum usage in terms of occupied passbands and the gaps between them. The cache may further be used to identify fragmentation in the representation and enhance spectral efficiency by enabling a domain specific application to use this representation and manage the configuration and position of the channels.

The Spectrum Layout Transformer 806 operates as a processor for transforming the representation of the spectrum layout in response to changes within the band spectrum. When there is a change, such as the creation, deletion, or modification of a channel, this transformer updates the Spectrum Layout Cache 804 to reflect these changes in real-time.

The Channel Frequency Update Handler 808 interfaces with the Channel Frequency Lookup Table 802 and acts upon new frequency markers or changes to existing markers. Hander 808 detects changes in frequency markers against a channel and feeds the same to the Spectrum Layout Transformer 806 which further updates both the first and second balanced tree data structures in response to these changes.

In operation, system 800 enables an efficient real-time representation of band spectrum occupancy using balanced tree data structures to represent channels and gaps. The device utilizes one or more processors configured to maintain, update, and dynamically modify these data structures, accommodating changes in frequency associated with the channels to correspondingly adjust the representation of gaps. This management of the representation occurs irrespective of bandwidth granularity and is done on non-discrete scale of frequencies.

A domain specific application may read the Spectrum Layout Cache 804 and recalculate the optimal location for a new channel by using the nodes of the second balanced tree data structure to find the smallest or the largest contiguous spectrum gap. This helps in reallocating bandwidth within the band spectrum to minimize gap fragmentation. The domain may be one of fiber-optics networks, wireless and radio networks, cable television networks, etc.

The domain specific application may analyze spectral trends over time using historical data from the first and second balanced tree data structures to predict changes in channel occupancy. By performing predictive analysis on the potential for future gap fragmentation, the domain specific application may maintain optimal spectrum utilization.

When identifying spectrum gaps, the domain specific application measures the spectral width of each gap and categorizes the gaps based on their widths. This aids in the accurate management of the spectrum and ensures that spectrum gaps are optimally utilized.

The Spectrum Layout Transformer 806 employs transform functions to update channel entries and gap entries in the balanced tree data structure efficiently, ensuring continuous tracking of spectrum usage. This involves actions such as shifting nodes within the second balanced tree data structure (i.e., the gap entries) to consolidate spectrum gaps and merging adjacent nodes in the balanced tree data structure to form a larger gap. Additionally, this may involve actions of splitting a larger gap into two smaller gaps by creating a new node in the second balanced tree data structure.

Further, system 800 is capable of interfacing with an optical line system to adjust channel allocation based on the updated balanced tree data structures. This capability facilitates that the optical line system can adapt to varying demands in the traffic efficiently avoiding fragmentation in the band spectrum.

The system adjusts for changes in the band spectrum non-linearity when mapping the active channels and spectrum gaps into the balanced tree data structures, maintaining accurate spectrum occupancy representation. This enables the system to provide real-time, reliable data about the band spectrum's status.

System 800 may also provide notifications to a network management system when updates occur in the balanced tree data structures. This ensures that network management systems are always updated with the latest spectrum occupancy data.

Furthermore, system 800 depicted in FIG. 8a facilitates random access to positions and neighborhood relations of channels and gaps within the band spectrum, providing external applications with visualization capabilities and access to the balanced tree data structure. It employs transform functions to update channel entries and gap entries in the balanced tree data structure efficiently, ensuring continuous tracking of spectrum availability.

As indicated above, FIG. 8a is provided as an example. Other examples may differ from what is described with regard to FIG. 8a.

FIG. 8b shows an example of a balanced tree data structure consistent with an aspect of the present disclosure. As generally understood, a balanced tree is a data structure where the height of its left and right subtrees differ by no more than one for every node. This ensures that the tree is evenly distributed, preventing it from becoming excessively tall or skewed, which would slow down operations like searching, inserting, and deleting data. Table 4 lists examples of data that may be associated with the nodes of the balanced tree further shown in FIG. 8b.

A balanced tree may be implemented using a variety of algorithms as there in the prior art for example: Red-Black tree, AVL tree, B+ tree, Splay tree, etc.

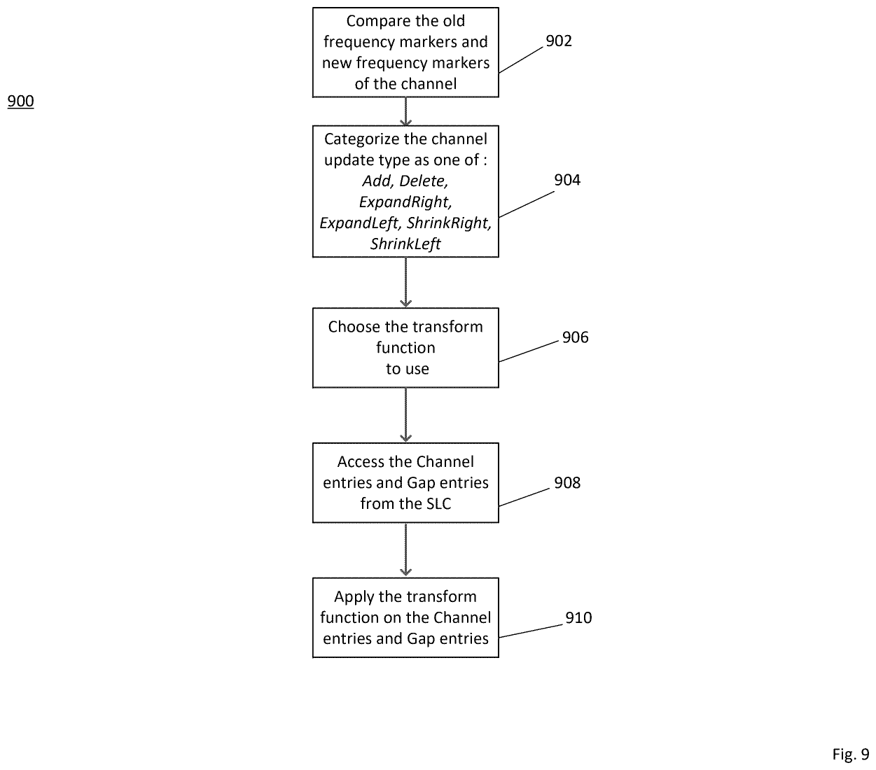

FIG. 9 depicts an example 900 flow associated with a Spectrum Layout Transformer 806. The process starts with comparing the old frequency markers and new frequency markers of the channel at step 902. This initial step evaluates the differences between the previous and current frequency markers, which represent the frequency boundaries occupied by the channel within the spectrum. The comparison provides essential data for a system configured to maintain a real-time representation of band spectrum occupancy using a balanced tree data structure to represent channels and gaps. This evaluation helps determine what type of operation is required to update the channel entries accurately.

Following the comparison, at step 904, the channel update type is categorized into one of the following types: Add, Delete, ExpandRight, ExpandLeft, ShrinkRight, or ShrinkLeft. Categorizing the update type is crucial because it dictates which specific transformation function will be applied. For instance, an ‘Add’ operation involves the system accommodating a new channel in the channel entries balanced tree data structure by adding a corresponding node representing the channel's frequency range. This ‘Add’ operation may further involve splitting an existing gap into two gaps and accommodating the new gap by adding a corresponding node in the gap entries balanced tree data structure. A ‘Delete’ operation involves the removal of an existing channel, where the one or more processors are configured to remove a channel from the channel entries balanced tree data structure by deleting the corresponding node and merging adjacent gap nodes in the gap entries balanced tree data structure by deleting an existing node. ‘ExpandRight’ and ‘ExpandLeft’ operations indicate that the channel is expanding its frequency range to the right or left, respectively, while ‘ShrinkRight’ and ‘ShrinkLeft’ indicate that the channel is reducing its frequency range. The pseudo code for the ‘Add’, ‘Delete’, ‘ExpandRight’, ‘ExpandLeft’, ‘ShrinkRight’ and ‘ShrintLeft’ transform functions is set forth in Appendix-I.

Once the channel update type is categorized, the appropriate transform function is chosen at step 906. The selection of the transform function involves determining the most suitable algorithm to apply based on the categorized update type. This step ensures that the right transformation logic is executed to update the channel entries and gap entries in the Spectrum Layout Cache 804 efficiently. The system further leverages these transform functions to update channel entries and gap entries in the balanced tree data structure efficiently, maintaining the Spectrum Layout Cache data integrity.

Next, the Spectrum Layout Transformer 806 accesses the Channel entries and Gap entries from the Spectrum Layout Cache (SLC) at step 908.

The chosen transform function is then applied to the Channel entries and Gap entries at step 910. The system updates the balanced tree data structures in response to frequency changes associated with channels, thereby adjusting the representation of gaps by dynamically modifying the balanced tree data structures in response to bandwidth allocation changes. At this step, the balanced tree data structure changes where a new node may be created, an existing node may be deleted, and the contents of an existing node may change, all depending on the new frequency markers of the channel. The transformer is designed so that the system maintains a real-time representation of band spectrum occupancy using these balanced tree data structures.

The spectrum layout transformer effectively manages band spectrum occupancy using these balanced tree data structures by constantly updating them to reflect the latest allocation and deallocation of spectrum resources. This provides an improved method for representing real-time band spectrum occupancy, achieving greater efficiency and reduced time-complexity compared to prior art.

As indicated above, FIG. 9 is provided as an example. Other examples may differ from what is described with regard to FIG. 9.

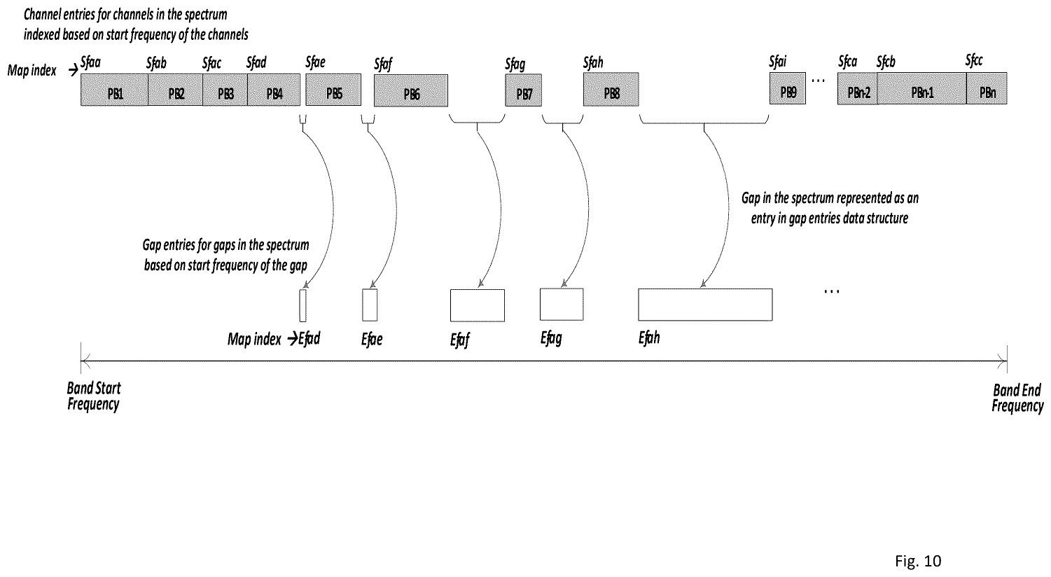

Referring now to FIG. 10, a visual depiction of the spectrum representation for is shown. The figure illustrates the real-time occupancy of a band spectrum including both channels, referred to as passbands, and gaps, representing the unused portion of the band.

The channel entries, represented on top, include channels indexed based on the start frequency of each channel, denoted as PB1 (Sfaa), PB2 (Sfab), PB3 (Sfac), PB4 (Sfad), PB5 (Sfae), PB6 (Sfaf), PB7 (Sfag), PB8 (Sfah), PB9 (Sfai), PBn2 (Sfca), PBn1 (Sfcb), and PBn (Sfcc). The prefix ‘Sf’ here denotes Start Frequency of the channel and the prefix ‘Ef’ denotes End Frequency of the channel. Each entry signifies a division of the spectrum allocated for use, where signals carrying user data are transmitted.

Below the channel entries are the gap entries for the spectrum in the gap entries data structure. The gaps, representing the spectrum not currently utilized for transmitting user data, are indexed based on the start frequency of each gap. The gaps are indexed by Efad, Efae, Efaf, Efag, and Efah. These gaps are critical in visualizing the unoccupied segments of the spectrum and facilitates efficient management and packing of channels to prevent fragmentation and maintain spectrum efficiency.

In accordance with the method of managing spectrum representation, the device processes first and second information associated with a band spectrum, where the first information includes the frequencies associated with active channels (as depicted by the channel entries), and the second information includes frequencies associated with gaps (as represented by the gap entries). The method further includes displaying a representation of the band and the gaps on a display.

The representation, as illustrated in FIG. 10, provides a comprehensive view of how both the channels and the gaps are laid out across the band spectrum. This visualization assists in identifying the gaps and facilitating effective management to balance the load on the spectrum or to allocate available bandwidth for new services, thereby optimizing spectrum utilization. This figure illustrates an exemplary visualization model that can be embodied in a system to enable real-time spectrum occupancy to be visible and easily interpretable, thus reinforcing the stated method of displaying a representation of the spectrum on a device.

As indicated above, FIG. 10 is provided as an example. Other examples may differ from what is described with regard to FIG. 10.

The foregoing disclosure provides illustration and description, but is not intended to be exhaustive or to limit the implementations to the precise forms disclosed. Modifications may be made in light of the above disclosure or may be acquired from practice of the implementations.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The actual specialized control hardware or software code used to implement these systems and/or methods is not limiting of the implementations. Thus, the operation and behavior of the systems and/or methods are described herein without reference to specific software code—it being understood that software and hardware can be used to implement the systems and/or methods based on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

Although particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiple of the same item.

When “a processor” or “one or more processors” (or another device or component, such as “a controller” or “one or more controllers”) is described or claimed (within a single claim or across multiple claims) as performing multiple operations or being configured to perform multiple operations, this language is intended to broadly cover a variety of processor architectures and environments. For example, unless explicitly claimed otherwise (e.g., via the use of “first processor” and “second processor” or other language that differentiates processors in the claims), this language is intended to cover a single processor performing or being configured to perform all of the operations, a group of processors collectively performing or being configured to perform all of the operations, a first processor performing or being configured to perform a first operation and a second processor performing or being configured to perform a second operation, or any combination of processors performing or being configured to perform the operations. For example, when a claim has the form “one or more processors configured to: perform X; perform Y; and perform Z,” that claim should be interpreted to mean “one or more processors configured to perform X; one or more (possibly different) processors configured to perform Y; and one or more (also possibly different) processors configured to perform Z.”

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

### APPENDIX

This section provides a reference pseudo code of the various transform functions which may be used to manage the channel entries and gap entries balanced tree data structures for a standard C or standard L band of an optical line system which is 4.8 THz wide. The pseudo code written here refers usage of the C++ standard library ‘map’ data structure which internally uses a Red-Black tree as a base implementation. The term ‘PassbandMap’ here should be interpreted as the channel entries balanced tree data structure. The term ‘GapMap’ here should be interpreted as the gap entries balanced tree data structure.
if(spectrum_type==CBand)
   Band_Sf=191312500 MHz;
   Band_Ef=196137500 MHz;
if(spectrum_type==LBand)
   Band_Sf=186237500 MHz;
   Band_Ef=191062500 MHz;
--------------------------------
ADD(passband: Sf, Ef)
--------------------------------
STEP-1:=
   right_gap_end_frequency=0;
      left_gap_start_frequency=0;
   PBnext=next entry in the PassbandMap for index ‘Sf’;
   PBprev=prev entry in the PassbandMap for index ‘Sf’;
   if (PBnext entry exists in PassbandMap)
      right_gap_end_frequency=PBnext.Sf;
   else
      right_gap_end_frequency=Band_Ef;
   if (PBprev entry exists in PassbandMap)
      left_gap_start_frequency=PBprev.Ef;
   else
      left_gap_start_frequency=Band_Sf;
STEP-2:=
   GapOld=entry in the GapMap for index ‘left_gap_start_frequency’;
   if (GapOld entry doesn't exists in GapMap)
      throw exception;
   else
      erase entry for GapOld from the GapMap;
STEP-3:=
   if (left_gap_start_frequency<Sf)
   {
      NewGapLeft;
      NewGapLeft.Sf=left_gap_start_frequency;
      NewGapLeft.Ef=Sf;
      insert entry for NewGapLeft to GapMap with index NewGapLeft.Sf;
   } else {
      if(left_gap_start_frequency !=Sf) {
         throw exception;
      }
   }
STEP-4:=
   if (right_gap_end_frequency>Ef)
   {
      NewGapRight;
      NewGapRight.Sf=Ef;
      NewGapRight.Ef=right_gap_end_frequency;
      insert entry for NewGapRight to GapMap with index NewGapRight.Sf;
   } else {
      if(right_gap_end_frequency !=Ef) {
         throw exception;
      }
   }
STEP-4
   insert entry for passband [Sf, Ef] to PassbandMap with index Sf;
--------------------------------
DELETE(passband: Sf, Ef)
--------------------------------
STEP-1:=
   right_gap_end_frequency=0;
      left_gap_start_frequency=0;
   PBnext=next entry in the PassbandMap for index ‘Sf’;
   PBprev=prev entry in the PassbandMap for index ‘Sf’;
   if (PBnext entry exists in PassbandMap)
      right_gap_end_frequency=PBnext.Sf;
   else
      right_gap_end_frequency=Band_Ef;
   if (PBprev entry exists in PassbandMap)
      left_gap_start_frequency=PBprev.Ef;
   else
      left_gap_start_frequency=Band_Sf;
STEP-2:=
   if(right_gap_end_frequency>Ef) {
      OldGapRight=entry in the GapMap for index ‘Ef’;
      if(OldGapRight entry exists in GapMap) {
         erase entry for OldGapRight from the GapMap;
      } else {
         throw exception;
      }
   } else {
      if(right_gap_end_frequency !=Ef) {
         throw exception;
      }
   }
STEP-3
   if(left_gap_start_frequency<Sf) {
      OldGapLeft=entry in the GapMap for index ‘left_gap_start_frequency’;
      if(OldGapLeft entry exists in GapMap) {
         erase entry for OldGapLeft from the GapMap;
      } else {
         throw exception;
      }
   } else {
      if(left_gap_start_frequency !=Sf) {
         throw exception;
      }
   }
STEP-4:=
   erase entry indexed by Sf from the PassbandMap;
STEP-5
   GapNew;
   GapNew.Sf=left_gap_start_frequency;
   GapNew.Ef=right_gap_end_frequency;
      insert entry for GapNew to GapMap with index GapNew.Sf;
--------------------------------
EXPAND_LEFT(passband: Sfnew, Sfold, Ef)
--------------------------------
STEP-1:=
   PBx=entry in the PassbandMap for index Sfold;
   if (PBx entry doesn't exist in PassbandMap) {
      throw exception;
   }
STEP-2:=
   PBprev=prev entry in the PassbandMap for index ‘Sfold’;
   left_gap_start_frequency=0;
   if (PBprev entry exists in PassbandMap)
      left_gap_start_frequency=PBprev.Ef;
   else
      left_gap_start_frequency=Band_Sf;
STEP-3
   OldGapLeft=entry in the GapMap for index ‘left_gap_start_frequency’;
   if(OldGapLeft entry doesn't exists in GapMap) {
      throw exception;
   }
   if(left_gap_start_frequency<Sfnew) {
      Update the entry corresponding to the OldGapLeft in the GapMap with new frequency parameters as [OldGapLeft.Sf, Sfnew];
   } else {
      if(left_gap_start_frequency !=Sfnew) {
         throw exception;
      } else {
         erase entry for OldGapLeft from the GapMap;
      }
   }
STEP-4:=
   erase entry indexed by Sfold from the PassbandMap;
STEP-5:=
   insert entry for passband [Sfnew, Ef] to PassbandMap with index Sfnew;
--------------------------------
SHRINK_LEFT(passband: Sfnew, Sfold, Ef)
--------------------------------
STEP-1:
   PBx=entry in the PassbandMap for index Sfold;
   if (PBx entry doesn't exist in PassbandMap) {
      throw exception;
   }
STEP-2:=
   PBprev=prev entry in the PassbandMap for index ‘Sfold’;
   left_gap_start_frequency=0;
   if (PBprev entry exists in PassbandMap)
      left_gap_start_frequency=PBprev.Ef;
   else
      left_gap_start_frequency=Band_Sf;
STEP-3:=
   if(left_gap_start_frequency<Sfold) {
      OldGapLeft=entry in the GapMap for index ‘left_gap_start_frequency’;
      if(OldGapLeft entry doesn't exists in GapMap) {
         throw exception;
      }
      Update the entry corresponding to the OldGapLeft in the GapMap with new frequency parameters as [OldGapLeft.Sf, Sfnew];
   } else {
      if(left_gap_start_frequency !=Sfold) {
         throw exception;
      }
      NewGapLeft;
      NewGapLeft.Sf=left_gap_start_frequency;
      NewGapLeft.Ef=Sfnew;
      insert entry for NewGapLeft to GapMap with index NewGapLeft.Sf;
   }
STEP-4:=
   erase entry indexed by Sfold from the PassbandMap;
STEP-5:=
   insert entry for passband [Sfnew, Ef] to PassbandMap with index Sfnew;
--------------------------------
EXPAND_RIGHT(passband: Sf, Efold, Efnew)
--------------------------------
STEP-1:=
   PBx=entry in the PassbandMap for index Sf;
   if (PBx entry doesn't exist in PassbandMap) {
      throw exception;
   }
STEP-2:=
   PBnext=next entry in the PassbandMap for index ‘Sf’;
   right_gap_end_frequency=0;
   if (PBnext entry exists in PassbandMap)
      right_gap_end_frequency=PBnext.Sf;
   else
      right_gap_end_frequency=Band_Ef;
STEP-3:=
   if(right_gap_end_frequency>Efold) {
      OldGapRight=entry in the GapMap for index ‘Efold’;
      if(OldGapRight entry doesn't exists in GapMap) {
         throw exception;
      }
      erase entry for OldGapRight from the GapMap;
      if(Efnew<right_gap_end_frequency) {
         NewGapRight;
         NewGapRight.Sf=Efnew;
         NewGapRight.Ef=right_gap_end_frequency;
         insert entry for NewGapRight to GapMap with index NewGapRight.Sf;
      } else {
         if(Efnew !=right_gap_end_frequency) {
         throw exception;
         }
      }
   } else {
      throw exception;
   }
STEP-4:=
   Update the entry corresponding to the PBx in the PassbandMap with new frequency parameters as [Sf, Efnew];
--------------------------------
SHRINK_RIGHT(passband: Sf, Efold, Efnew)
--------------------------------
STEP-1:=
   PBx=entry in the PassbandMap for index Sf;
   if (PBx entry doesn't exist in PassbandMap) {
      throw exception;
   }
STEP-2:=
   PBnext=next entry in the PassbandMap for index ‘Sf’;
   right_gap_end_frequency=0;
   if (PBnext entry exists in PassbandMap)
      right_gap_end_frequency=PBnext.Sf;
   else
      right_gap_end_frequency=Band_Ef;
STEP-3:=
   if(Efold<right_gap_end_frequency) {
      OldGapRight=entry in the GapMap for index ‘Efold’;
      if(OldGapRight entry doesn't exists in GapMap) {
         throw exception;
      }
      erase entry for OldGapRight from the GapMap;
      } else {
      if(Efold !=right_gap_end_frequency) {
         throw exception;
      }
   }
   NewGapRight;
   NewGapRight.Sf=Efnew;
   NewGapRight.Ef=right_gapend_frequency;
   insert entry for NewGapRight to GapMap with index NewGapRight.Sf;
STEP-4:=
   Update the entry corresponding to the PBx in the PassbandMap with new frequency parameters as [Sf, Efnew];

What is claimed is:

1. A method comprising:
mapping, by a device, active channels within a band spectrum into a first balanced tree data structure wherein each node of the first balanced tree data structure represents a respective channel;
identifying, by the device, spectrum gaps within the band spectrum based on the nodes of the first balanced tree data structure and mapping the spectrum gaps into a second balanced tree data structure wherein each node of the second balanced tree data structure represents a respective spectrum gap; and
updating, by the device, the first balanced tree data structure and the second balanced tree data structure in response to a change detected in an active channel by adding, deleting, or modifying the nodes of the first and second balanced tree data structures to reflect the change in real-time occupancy of the band spectrum.

2. The method of claim 1, further comprising: reallocating, by the device, bandwidth within the band spectrum to minimize gap fragmentation based on the nodes of the second balanced tree data structure.

3. The method of claim 1, further comprising: detecting, by the device, a change in bandwidth utilization and automatically updating both the first and second balanced tree data structures in response to the change.

4. The method of claim 1, further comprising: visualizing, by the device, the representation of the active channels and spectrum gaps to a user interface device.

5. The method of claim 1, further comprising: calculating, by the device, an optimal location for a new channel using the nodes of the second balanced tree data structure to find the largest or smallest contiguous spectrum gap.

6. The method of claim 1, further comprising: providing, by the device, notifications to a network management system when updates occur in the balanced tree data structures.

7. The method of claim 1, further comprising: performing, by the device, predictive analysis on the potential for future gap fragmentation within the band spectrum.

8. The method of claim 1, further comprising: optimizing, by the device, the alignment of channels within the band spectrum for spectral efficiency based on the nodes of the first and second balanced tree data structure.

9. The method of claim 1, further comprising: analyzing, by the device, spectral trends over time using historical data of the first and second balanced tree data structures to predict changes in channel occupancy.

10. The method of claim 1, wherein updating the first and second balanced tree data structures comprises one or more of: shifting nodes within either balanced tree data structure to consolidate spectrum gaps; or merging adjacent nodes in the second balanced tree data structure to form a larger gap; or splitting a node in the second balanced tree data structure where a gap is decomposed into smaller gaps.

11. The method of claim 1, wherein identifying spectrum gaps further comprises measuring the spectral width of each gap and categorizing the gaps based on their widths.

12. The method of claim 1, further comprising: interfacing, by the device, with an optical line system to adjust channel allocation based on the updated balanced tree data structures.

13. The method of claim 1, further comprising: compensating, by the device, for band spectrum non-linearity when mapping the active channels and spectrum gaps into the balanced tree data structures to maintain accurate spectrum occupancy representation.

14. A device, comprising:
one or more processors configured to:
maintain a real-time representation of a band spectrum occupancy using a balanced tree data structure to represent channels and gaps;
update the balanced tree data structure in response to frequency changes associated with the channels to correspondingly adjust representation of the gaps; and
randomly access the channels and gaps in the balanced tree data structure to minimize fragmentation and optimize spectrum utilization irrespective of bandwidth granularity.

15. The device of claim 14, wherein the one or more processors are further configured to:
accommodate a new channel in the first balanced tree data structure by adding a corresponding node representing the channel's frequency range and splitting a node in the second balanced tree data structure where a gap is decomposed into smaller gaps.

16. The device of claim 14, wherein the one or more processors are further configured to:
remove a channel from the first balanced tree data structure by deleting the corresponding node and merging adjacent gap nodes in the second balanced tree data structure.

17. The device of claim 14, wherein the one or more processors are further configured to:
dynamically modify the size of a channel representation in the balanced tree data structure in response to bandwidth allocation changes.

18. The device of claim 14, wherein the one or more processors are further configured to:
update the balanced tree data structure with additional gap nodes when a channel is deleted or subdivided, ensuring continuous tracking of spectrum availability.

19. The device of claim 14, wherein the one or more processors are further configured to:
identify available spectrum for new channel allocation by assessing the gap nodes in the balanced tree data structure.

20. The device of claim 14, wherein the one or more processors are further configured to:
handle spectrum occupancy visualization for external applications by providing access to the balanced tree data structure.

21. The device of claim 14, wherein the one or more processors are further configured to:
utilize transform functions to update channel entries and gap entries in the balanced tree data structure efficiently, maintaining spectrum layout cache integrity.

22. A non-transitory computer-readable medium storing a set of instructions, the set of instructions comprising:
one or more instructions that, when executed by one or more processors of a device, cause the device to:
represent a real-time occupancy of a band spectrum in a telecommunications network by structuring a first balanced tree data structure of channels in increasing order of start frequencies, and a second balanced tree data structure of gaps based on the channels;
receive updates indicating changes to the channels, wherein the updates comprise at least one of: a creation of a new channel, a deletion of an existing channel, an expansion of an existing channel, or a contraction of an existing channel;
transform the first and second balanced tree data structures in real-time in response to the updates to the channels, wherein the transformations further result in adjusting entries in the second balanced tree data structure corresponding to the gaps; and
allow random access with improved time complexity to positions and neighborhood relations of said channels and gaps within the band spectrum independent of bandwidth granularity.

23. A method comprising:
receiving first and second information associated with a band spectrum, the first information including first frequencies associated with bands including signals carrying user data and second information associated with second frequencies associated with gaps in the band spectrum;
processing the first and second information; and
displaying a representation of the band and the gaps on a display.
